(19) United States
(12) Patent Application Publication
(10) Pub. No.: US 2008/0213685 A1
(43) Pub. Date: Sep. 4, 2008

(54) METHOD OF PROVIDING AN AQUEOUS DISPERSION SUITABLE FOR USE AS A CHEMICALLY PRODUCED TONER

(76) Inventor: Alan Toman, Apex, NC (US)

Correspondence Address: MYERS BIGEL SIBLEY & SAJOVEC, PO BOX 37428, RALEIGH, NC, 27627, US

(21) Appl. No.: 12/039,080

(22) Filed: Feb. 28, 2008

Related U.S. Application Data
(60) Provisional application No. 60/892,624, filed on Mar. 2, 2007.

(51) Int. Cl. G03G 9/12

(52) U.S. Cl. 430/112; 430/137.22

(57) ABSTRACT

Provided herein are methods of forming an aqueous dispersion suitable for use in a chemically produced toner that include a) dissolving a polyester resin in a volatile organic solvent to form a solution of the polyester in the volatile organic solvent; b) adding a neutralizing agent comprising at least one of an alkali metal hydroxide, an ammonium hydroxide and a tertiary amine, and water to the solution of the polyester in the volatile organic solvent to form a first aqueous dispersion; and c) heating the dispersion to remove solvent to provide a second aqueous dispersion. Also provided are aqueous dispersions formed by methods according to embodiments of the invention and toners resin compositions including an aqueous dispersion according to an embodiment of the invention.

### CROSS-REFERENCE TO RELATED APPLICATIONS

This application claims the benefit of U.S. Provisional Patent Application No. 60/892,624, filed Mar. 2, 2007, the disclosure of which is herein incorporated by reference in its entirety.

### FIELD OF THE INVENTION

The present invention relates to toner resins, and more particularly, to chemically produced toners (“CPTs”) and methods of making the same.

### BACKGROUND OF THE INVENTION

In typical dry-type electrophotographic processes, latent electrostatic images formed on a photoconductor are developed by means of a triboelectrically-charged toner. Specifically, when an image is formed by a photographic copying machine, a surface of a roller composed of a photoconductive and photosensitive material is charged. An electrostatic latent image is formed by exposure to the light reflected from the surface of an original to be copied. The latent image is developed by a toner, with the formed visible image being transferred to a paper or the like. The transferred image is fixed on the paper by compression under heating, and thus a copy print is obtained.

A typical toner includes several components including a toner resin, a colorant, and an electrostatic carrier material. The toner resin is of particular importance in that it serves to bind the other toner components. Typically, toner resins are formed from various materials such as bisphenol-epoxy resins described in U.S. Pat. No. 5,061,588; silicone-based resins as described in U.S. Pat. No. 5,089,547; and styrene-butadiene copolymer resins as described in U.S. Pat. No. 5,324,611. In spite of the above-processes, there remains a need in the art to obtain a toner resin having properties for improved performance in high speed copying operations. In particular, it is often problematic when carrying out an image-forming process at high speeds as to how to increase the speed of fixing a toner image followed by visualizing an electrostatic latent image to the surface of the recording material. Toner resins which are believed to be suitable for such high speed processes should melt sharply at relatively low temperatures, possess good stability, and blend well with colorant. Additionally, toner resins should not develop significant blocking or caking at ambient temperatures.

Toners are often produced by a milling process. However milling processes have limitations with respect to providing a narrow particle size distribution primarily due to limits in the classification step. One way of eliminating the classification step is to use a chemical route in producing toners. Chemical routes include suspension polymerization, solution-dispersion processes, and aggregation processes. Exemplary processes are described, for example, in U.S. Pat. Nos. 4,996,127; 5,418,108; and 5,066,560, and U.S. Publication No. 2005/0175921A1.

There, however, remains a need for aqueous dispersions, suitable for use in a chemically produced toners, that have a relatively narrow size distribution, a controlled non-volatile content and a relatively low concentration of volatile organic solvent.

### SUMMARY OF THE INVENTION

Provided according to some embodiments of the invention are methods of producing an aqueous dispersion suitable for use in a chemically produced toner, the methods including:

a) dissolving a polyester in a volatile organic solvent to form a solution of the polyester in the volatile organic solvent;

b) adding a neutralizing agent including at least one of an alkali metal hydroxide, an ammonium hydroxide and a tertiary amine, and water to the solution of the polyester in the volatile organic solvent to form a first aqueous dispersion;

c) heating the first aqueous dispersion to remove volatile organic solvent to provide a second aqueous dispersion. In some embodiments, such aqeuous dispersions have a mean particle size in the range of about 10 to about 500 nm. In some embodiments, such aqueous dispersions have a non-volatile content in a range of about 25 to about 55 percent. Additionally, in some embodiments, such aqueous dispersions have an organic solvent concentration of less than about 5000 ppm %.

According to some embodiments of the invention, the volatile organic solvent includes a volatile organic solvent that is miscible with water. In some embodiments, the volatile organic solvent is selected from the group consisting of methylethyl ketone, acetone, methylpropyl ketone, and isopropanol. In addition, in some embodiments, the volatile organic solvent includes an organic solvent that is immiscible with water, such as hexane.

According to some embodiments of the invention, the step of heating the dispersion is conducted at a temperature in a range of about 25° to about 105° C. Additionally, in some embodiments, the neutralizing agent includes at least one the group consisting of hydroxides of lithium, potassium and sodium. In some embodiments, the first aqueous dispersion has a pH in a range of about 6 to about 8. Furthermore, in some embodiments, the polyester is an etherified bisphenol A-containing polyester.

Also provided according to some embodiments of the invention are aqueous dispersions produced by a method according to an embodiment of the invention.

Additionally, provided according to some embodiments of the invention are toner resin compositions that include an aqueous dispersion according to an embodiment of the invention and a colorant. Such toner resins may also include an inhibitor, a paraffin, a lubricant, a shrink-reducing additive and/or a charge control agent.

### DETAILED DESCRIPTION OF EXEMPLARY EMBODIMENTS OF THE INVENTION

The invention is described more fully hereinafter. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

To this end, the present invention provides methods of producing an aqueous dispersion suitable for use as a chemically produced toner.

According to some embodiments of the invention, the methods include a) dissolving a polyester resin in a volatile organic solvent to form a solution of the polyester in the volatile organic solvent; b) adding a neutralizing agent comprising at least one of an alkali metal hydroxide, an ammonium hydroxide and a tertiary amine, and water to the solution of the polyester in the volatile organic solvent to form a first aqueous dispersion; and c) heating the dispersion to remove solvent to provide a second aqueous dispersion.

The polyester resins used according to embodiments of the invention are typically formed from the reaction between a polybasic acid or anhydride and a polyhydric alcohol. Known and suitable processes for preparing such polyesters are described in U.S. Pat. Nos. 3,787,526; 4,588,668; 4,933,252; 4,939,059; 4,960,664; and 5,241,019; along with Canadian Patent No. 1,032,804. The disclosures of these references are incorporated herein by reference in their entirety. Particular commercial products that may be used according to some embodiments of the invention include resins by Reichhold Inc., including Fine-Tone® resins such as Fine-Tone® T-382ES-HMW, Fine-Tone® EM-185661 and Fine-Tone® XP-777.

Exemplary polybasic acids or anhydrides thereof include dicarboxylic acids such as, but not limited to, maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azealic acid, malonic acid, alkenyl succinic acids such as n-dodecenylsuccinic acid, dodecylcucinic acid and octadecenylsuccinic acid, and mixtures thereof. Lower alkyl esters of any of the above may also be employed.

Additionally, polybasic acids or anhydrides thereof having not less than three carboxylic acid groups may be employed. Such compounds include 1,2,4-benzenetricarboxylic acid, 1,3,5-benzene tricarboxylic acid, 1,2,4-cyclohexane tricarboxylic acid, 2,5,7-naphthalenetricarboxylic acid, 1,2,4-naphthalenetricarboxylic acid, 1,3,4-butane tri carboxylic acid, 1,2,5-hexanetricarboxylic acid, 1,3-dicarboxy-2-2-methyl-2-methylcarboxypropane, 1,3-dicarboxy-2-methyl-2-carboxymethylpropane, tetra(carboxymethyl)methane, 1,2,7,8-octane tetracarboxylic acid, and mixtures thereof. The polybasic acid or anhydride may be employed in any suitable amount, and in some embodiments, are present in an amount of from about 30 to 50 percent based on the weight of the polyester resin.

Any of the polyhydric alcohols which are appropriate in polyester-forming reactions may be utilized. Such compounds include, but are not limited to, any suitable glycols. As used herein, “glycols” refers to glycol compounds and bisphenols. Suitable glycol compounds include, for example, ethylene glycol, diethylene glycol, neopentyl glycol, dipropylene glycol, and polytetramethylene glycol. Suitable bisphenols include, for example, bispolyoxypropylene (2.2)-2,2-bis(4-hydroxyphenyl)propane, polyoxypropylene (3.3)-2,2-bis(4-hydroxyphenyl)propane, polyoxy ethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane. Diols may be employed such as, for example, 1,5-pentanediol, 1,4-butanediol, 1,6-hexanediol, 1,4-cyclohexanediol, and 1,4-cyclohexanedimethanol. Mixtures of any of the above compounds may be used.

Polyhydric alcohols that are suitable as branching agents may be used and include, for example, sorbitol, 1,2,3,6-hexatetrol, 1,4-sorbitan, pentaerythritol, dipentaerythritol, tripentaerythritol, sucrose, 1,2,4-butanetriol, 1,2,5-pentanetriol, glycerol, 2-methyl propanetriol, 2-methyl 1,2,4-butanetriol, trimethylol ethane, trimethylol propane, 1,3,5-trihydroxyethyl benzene, and mixtures thereof.

The polyhydric alcohols may be employed in any suitable amount, and in some embodiments, are present in an amount of from about 35 to 80 percent based on the weight of the polyester.

Known and appropriate esterification catalysts may be employed in the reaction between the polybasic acid or anhydride and polyhydric alcohol. As an example, esterification catalysts may include organotin oxides and titanates such as stannous oxide, dibutyl tin oxide, dibutyl tin bis(ethylhexanoate), titanium isoproproxide, titanium ethoxide, and mixtures thereof. The catalysts may be employed in any suitable amount, preferably of from about 0.005 to 0.100 percent based on the weight of the polyester resin.

Polyfunctional epoxy resins which may be included with or in the polyester include virtually any reaction product of a polyfunctional halohydrin, such as epichlorohydrin, with a phenol or polyhydric phenol. Suitable phenols or polyhydric phenols include, for example, resorcinol, tetraphenol ethane, and various bisphenols such as bisphenol-A, 4,4′-dihydroxydiphenylsulfone, 4,4′-dihydroxy biphenyl, 4,4′-dihydroxydiphenylmethane, 2,2′-dihydroxydiphenyloxide, and the like. Other bisphenol type epoxy resins which may be used are glycidyl ethers and beta-methyl glycidyl ethers of bis(4-hydroxyphenyl)methane (bisphenol F); 1,1-bis(4-hydroxyphenyl)ethane (bisphenol AD), and the like. Mixtures of any of the above may be employed. The bispehnols may also be etherified using known techniques.

The polyfunctional epoxy resin may also be selected from any of the appropriate epoxy novalac resins. The term “epoxy novolac resin” as used herein means an epoxy resin made by the reaction of epichlorohydrin with a novolac resin. A novolac resin is a condensate of a phenol compound with formaldehyde that is prepared in the presence of acid catalysts. The phenol compound can be phenol itself, or such compounds as the cresols, xylenols, resorcinol, naphthols, and the like. Epoxy novolac resins used may have epoxy functionalities which are typically in the range of 2.5 to 6. Other polyfunctional epoxy resins which may be employed include isocyanurates such as, for example, triglycidyl isocyanurate.

The polyfunctional epoxy resin may be employed in any appropriate amount. In some embodiments, the epoxy resin is used in an amount of from about 0.1 to 50 percent based on the weight of the resin composition, in some embodiments, from about 0.5 to 40 weight percent, and in some embodiments from about 2 to 30 weight percent.

As used herein, the term “volatile organic solvent” includes any organic solvent that may be removed from the first aqueous dispersion during the heating step (c) at a faster rate than water. Suitable volatile organic solvents include those solvents that are miscible with water, such as methylethyl ketone, acetone, methylpropyl ketone, and isopropanol, and mixtures or blends thereof. The volatile organic solvent may also include an organic solvent that is immiscible in water, such as hexane. In some cases, a cosolvent system, e.g., a combination of a water miscible and a water immiscible solvent, may be used such that an ternary azeotrope with water is formed. The formation of the ternary azeotrope may allow for removal of increased amounts of organic solvent, such that, in some cases, an aqueous dispersion having a very low residual solvent concentration (e.g., less than 25 ppm) may be formed. Table 1 provides examples of azeotropes that may be formed according to some embodiment of the invention.

TABLE 1

| | | | Azeotrope | | | | | |
|---|---|---|---|---|---|---|---|---|
| | | | | | | | Relative | Specific |
| Components | | | | | | | volume | gravity |
| | Boiling | H₂O | Boiling | Percent composition | | | of | of layers |
| | Point | Solubility | Point | In | Upper | Lower | layers | or |
| Compounds | (° C.) | (g/100 ml) | (° C.) | azeotrope | Layer | Layer | at 20° C. | azeotrope |
| a. n-Butanol | 117.7 | 9 | 93.0 | 55.5 | 79.9 | 7.7 | U 71.5 | U 0.849 |
| b. Water | 100.0 | — | | 44.5 | 20.1 | 92.3 | L 28.5 | L 0.990 |
| a. Cyclohexane | 81.4 | none | 69.8 | 91.5 | 99.99 | 0.01 | U 93.2 | U 0.780 |
| b. Water | 100.0 | — | | 8.5 | 0.01 | 99.99 | L 6.8 | L 1.000 |
| a. Ethyl Acetate | 77.3 | 8.3 | 70.4 | 91.9 | 96.7 | 8.7 | U 95.0 | U 0.907 |
| b. Water | 100.0 | — | | 8.1 | 3.3 | 91.3 | L 5.0 | L 0.999 |
| a. 2-Ethyl | 185.0 | 0.14 | 99.1 | 20.0 | 97.4 | 0.1 | U 23.0 | U 0.838 |
| Hexanol | | | | | | | | |
| b. Water | 100.0 | — | | 80.0 | 2.6 | 99.9 | L 77.0 | L 1.000 |
| a. Hexane | 69 | 0.0013 | 61.6 | 94.4 | | | U 96.2 | U 0.660 |
| b. Water | 100.0 | — | | 5.6 | | | L 3.8 | L 1.000 |
| a. Methylethyl | 79.6 | 29 | 73.4 | 88.0 | | | | 0.834 |
| ketone | | | | | | | | |
| b. Water | 100.0 | — | | 12.0 | | | | |
| a. Methylpropyl | 101.7 | 4.3 | 83.8 | 80.4 | 96.7 | 4.3 | U 85.0 | U 0.812 |
| ketone | | | | | | | | |
| b. Water | 100.0 | — | | 19.6 | 3.3 | 95.7 | L 15.0 | L 0.999 |
| a. Propyl | 101.6 | 2.3 | 82.4 | 86.0 | | | | |
| Acetate | | | | | | | | |
| b. Water | 100.0 | — | | 14.0 | | | | |
| a. Toluene | 110.6 | 0.047 | 85.0 | 79.8 | 99.95 | 0.06 | U 82.0 | U 0.868 |
| b. Water | 100.0 | — | | 20.2 | 0.05 | 99.94 | L 18.0 | L 1.000 |
| a. Cyclohexane | 81.4 | none | 63.6 | 35.0 | 62.4 | 0.1 | U 95.4 | U 0.769 |
| b. Methylethyl | 79.6 | 29 | | 60.0 | 37.0 | 10.0 | L 5.5 | L 0.980 |
| ketone | | | | | | | | |
| c. Water | 100.0 | — | | 5.0 | 0.6 | 89.9 | | |
| a. Hexane | 68.0 | 0.0013 | 58.5 | 22.0 | | | | |
| b. Methylethyl | 79.6 | 29 | | 74.0 | | | | |
| ketone | | | | | | | | |
| c. Water | 100.0 | — | | 4.0 | | | | |

In step (a), as described above, a polyester resin is dissolved in a volatile organic solvent to form a solution of the polyester in the volatile organic solvent. The polyester may be present at any suitable concentration in the solution, but in some embodiments, the polyester is present in the solution at a concentration in a range of about 20 to about 80 weight percent.

In step (b), an alkali metal hydroxide, ammonium hydroxide and/or a tertiary amine is added to the polyester solution. Water is also added. One of ordinary skill in the art will understand that the polyester solution may be also added to the alkali metal hydroxide, ammonium hydroxide and/or a tertiary amine and that the water may be combined with the polyester solution in any manner before or after the addition of the alkali metal hydroxide, ammonium hydroxide and/or a tertiary amine.

Any suitable proportion of alkali metal hydroxide, ammonium hydroxide and/or a tertiary amine may be added to the polyester solution. In some embodiments, the alkali metal hydroxide and/or ammonium hydroxide is added at a concentration sufficient to neutralize between 40 and 100% of the carboxylic acid groups present in the polyester. Any suitable proportion of water may also be added to the polyester solution to form the aqueous dispersion. However, in some embodiments, the water is added at a concentration of about 20 to about 65% by weight based on the amount of polyester. Suitable alkali metal hydroxides include lithium, potassium, and sodium. The addition of the alkali metal hydroxide and/or ammonium hydroxide may result in an aqueous dispersion having a pH in a range of about 6 to about 8. If the aqueous dispersion has a pH below this level, the number of neutralized carboxylic acid groups on the polyester may not be optimal. This may result in fewer hydrophilic polymer chains, which may provide relatively poor polyester dispersion. If the pH is higher than about 8, this may indicate an undesirable excess of neutralizing agent. Such a dispersion may be stable, but the excess neutralizing agent may negatively effect on toner properties and/or cause undesirable odor.

The aqueous dispersions described herein may be formed using known dispersion techniques such as, for example, mixing with a paddle type stirrer in a reaction vessel. In some embodiments, the dispersions are formed using a stirrer speed between 100 and 1000 rpm.

In step (c), the aqueous dispersion is heated at a temperature in a range of 25° C. to 105° C., and in some embodiments in a range of 25° C. to 95° C., to remove the volatile organic solvent and form the second aqueous dispersion. The appropriate temperature will depend on the volatile organic solvent(s) used. The boiling points of particular azeotropic mixtures may be found in Table 1.

In some embodiments of the invention, the resulting aqueous dispersion may have a mean particle size in the range of about 10 to about 500 nm, In some embodiments, the resulting aqueous dispersion may have a non-volatile content in a range of about 25 to about 55 percent. Additionally, in some embodiments, the resulting aqueous dispersion may have an organic solvent concentration of less than about 1 weight %, in some embodiments, less than about 5000 ppm, in some embodiments, less than about 50 ppm, and in some embodiments, below 25 ppm.

Once made, the toner can include additional additives including, for example, inhibitors, paraffins, lubricants, and shrink-reducing additives. Any of the various suitable percentages of these additives can be used in conjunction with the toner resin composition. The toner resin composition typically includes a colorant. Exemplary colorants include a red pigment (e.g., red iron oxide, cadmium red, red lead oxide, cadmium, mercury sulfide, permanent red 4R, lithol red, pyrazolone red, watchung red, calcium salt, lake red D, brilliant carmine 6B, eosine lake, rhodamine lake B, alizaline lake, brilliant carmine 3B, or the like); a green pigment (e.g., chrome green, chrome oxide green, pigment green B, malachite green lake, fanal yellow green G, or the like); a blue pigment (e.g., Prussian blue, cobalt blue, alkali blue lake, victoria blue lake, phthalocyanine blue, metal-free phthalocyanine blue, phthalocyanine blue particle chlorine compound, fast sky blue, indanthrene blue BC, or the like); a magenta pigment (e.g., manganese violet, fast violet B, methyl violet lake, or the like); a yellow pigment (e.g., chrome yellow, zinc yellow, cadmium yellow, yellow oxide, mineral fast yellow, nickel titanium yellow, nables yellow, naphthol yellow S, hansa yellow G, hansa yellow 10G, benzidine yellow G, benzidine yellow GR, quinoline yellow lake, permanent yellow, NCG, tartrazine lake, or the like); an orange pigment (e.g., chrome orange, molybdenum orange, permanent orange GTR, indanthrene brilliant orange RK, vulcan orange, pyrazolone orange benzidine orange G, indanthrene brilliant orange GK, or the like); or a black pigment (e.g., carbon black, acetylene black, lamp black, aniline black, or the like). Suitable colorants are also disclosed in U.S. Pat. No. 3,989,648 to Lenhard et al. and U.S. Pat. No. 5,162,187 to Lyons et al., the disclosure of which are incorporated herein by reference in their entirety. Mixtures of any of the colorants may be used. The toner resin composition preferably includes from 1 to 20 percent by weight of colorant.

The toner resin composition can also include a charge control agent such as Nigrosine Base EX (available from Orient Kagaku K.K.); quaternary ammonium salt (P-51: available from Orient Kagaku K.K.); Nigrosine Bontron N-01 (available from Orient Kagaku K.K.); Sudatiefschwarz BB (Solvent Black 3, C.I. 26150), Fettschwarz HEN (C.I. No. 26150); Brilliantspiritschwarz TN (available from Farben Fabriken Bayer A.G.); Zapanschwarz X (available from Farberke Hechist A.G.); and an alkoxylated amine, alkyl amide, molybdic chelating agent and the like. Mixtures of any of the charge control agents may be used. Preferably, the toner resin composition includes about 1 to about 5 weight percent of charge control agent.

Various embodiments of the present invention are illustrated by the following Examples, which are provided for illustrative purposes and are not meant to limit the embodiments of the present invention in any way.

### EXAMPLES

### Example 1

1356.8 grams of an etherified bisphenol A containing polyester (Fine-Tone T-382ES-HMW from Reichhold, Inc.) was dissolved in 904.6 grams of methylethyl ketone. The mixture was heated to reflux and 11.0 grams of lithium hydroxide monohydrate dissolved in 58.6 grams of de-ionized water was added. 1976.6 grams of de-ionized water was then added over 2 hours. The dispersion was heated to 95° C. and solvent removed. The final dispersion has a mean volume particle size of 128 nm, a non-volatile content of 42.8% and a pH of 6.6.

### Example 2

1356.8 grams of an etherified bisphenol A containing polyester (Fine-Tone T-382ES-HMW from Reichhold, Inc.) was dissolved in 904.6 grams of methylethyl ketone. The mixture was heated to reflux and 14.7 grams of potassium hydroxide dissolved in 58.6 grams of de-ionized water was added. 1976.6 grams of de-ionized water was then added over 2 hours. The dispersion was heated to 95° C. and solvent removed. The final dispersion has a mean volume particle size of 216 nm, a non-volatile content of 42.3% and a pH of 6.6.

### Example 3

1600 grams of an etherified bisphenol A containing polyester (Fine-Tone EM-185661 from Reichhold, Inc.) was dissolved in 1600 grams of methylethyl ketone. 13 grams of lithium hydroxide monohydrate dissolved in 69.1 grams of de-ionized water was added. 2330.9 grams of de-ionized water was then added over 2 hours. The dispersion was heated to 45° C. and solvent removed by vacuum stripping. The final dispersion has a mean volume particle size of 228 nm, a non-volatile content of 41.7% and a pH of 7.5.

### Example 4

256.4 grams of an etherified bisphenol A containing polyester (Fine-Tone T-382ES-HMW from Reichhold, Inc.) and 2.6 grams of a styrenated acrylic polymer (ECO-675 from Johnson Polymers) were dissolved in 170.9 grams of methylethyl ketone. The mixture was heated to reflux and 6.8 grams of aqueous ammonium hydroxide (28 wt % ammonia) was added. 384.5 grams of de-ionized water was then added over 2 hours. The dispersion was heated to 95° C. and solvent removed. The final dispersion has a mean volume particle size of 135 nm and a pH of 6.3.

### Example 5

716.4 grams of an etherified bisphenol A containing polyester (Fine-Tone T-382ES from Reichhold, Inc.) was dissolved in 238.8 grams of methylethyl ketone. The solution was heated to reflux and 19.1 grams of aqueous ammonium hydroxide (28 wt % ammonia) was added. 875.6 grams of de-ionized water was then added over 2 hours and 15 minutes. The dispersion was heated to 97° C. and solvent was removed. The final dispersion had a % non-volatile content of 49.4, a viscosity of 78 cps, as measured by a Brookfield RVT viscometer, a mean volume particle size of 83 nm and a pH of 6.3.

### Example 6

300 grams of an etherified bisphenol A containing polyester (Fine-Tone XP-777 from Reichhold, Inc.) was dissolved in 190.3 grams of methylethyl ketone and 19.3 grams of cyclohexane. 3.5 grams of aqueous ammonium hydroxide (28 wt % ammonia) was then added. 450 grams of de-ionized water was then added over 70 minutes. The dispersion was heated to 100° C. and solvent was removed. The dispersion has a mean volume particle size of 195 nm, a non-volatile content of 46.4% and a pH of 5.7. The level of residual solvent was less than 25 parts per million.

### Example 7

300 grams of Fine-Tone XP-777 was dissolved in 109.3 grams of methyethyl ketone and 19.3 grams of n-hexane. 3.5 grams of aqueous ammonium hydroxide (28 wt % ammonia) was added. 450 grams of de-ionized water was then added over 1 hour. The dispersion was heated to 101° C. and solvent was removed. The final dispersion had a % non-volatile content of 41.8, a mean volume particle size of 173 nm and a pH of 5.8.

### Example 8

300 grams of Fine-Tone XP-777 was dissolved in 100 grams of methylethyl ketone and 28.6 grams of cyclohexane. 3.3. grams of aqueous ammonium hydroxide (28 wt % ammonia) was added. 450 grams of de-ionized water was then added over 50 minutes. The dispersion was heated to 100° C. and solvent was removed. The final dispersion had a mean volume particle size of 224 nm and a pH of 5.7.

### Example 9

300 grams of Fine-Tone XP-777 was dissolved in 128.6 grams of methylpropyl ketone. 3.5 grams of aqueous ammonium hydroxide (28 wt % ammonia) was added. 450 grams of de-ionized water was then added over 70 minutes. The dispersion was heated to 101° C. and solvent was removed. The final dispersion had a mean volume particle size of 355 nm.

In the specification, there have been disclosed embodiments of the invention and, although specific terms are employed, they are used in a generic and descriptive sense only and not for purposes of limitation. The following claims are provided to ensure that the present application meets all statutory requirements as a priority application in all jurisdictions and shall not be construed as setting forth the full scope of the present invention.

That which is claimed:

1. A method of producing an aqueous dispersion suitable for use in a chemically produced toner, the method comprising:
a) dissolving a polyester in a volatile organic solvent to form a solution of the polyester in the volatile organic solvent;
c) adding a neutralizing agent comprising at least one of an alkali metal hydroxide, an ammonium hydroxide and a tertiary amine, and water to the solution of the polyester in the volatile organic solvent to form a first aqueous dispersion;
c) heating the first aqueous dispersion to remove volatile organic solvent to provide a second aqueous dispersion having a mean particle size in the range of about 10 to about 500 nm, a non-volatile content in a range of about 25 to about 55 percent and an organic solvent concentration of less than about 5000 ppm %.

2. The method according to claim 1, wherein the volatile organic solvent comprises at least one organic solvent selected from the group consisting of methylethyl ketone, acetone, methylpropyl ketone, and isopropanol.

3. The method according to claim 1, wherein the volatile organic solvent comprises an organic solvent that is immiscible with water.

4. The method according to claim 3, wherein the volatile organic solvent comprises hexane.

5. The method according to claim 3, wherein the volatile organic solvent further comprises an organic solvent that is miscible with water.

6. The method according to claim 5, wherein the organic solvent comprises at least one organic solvent selected from the group consisting of methylethyl ketone, acetone, methylpropyl ketone, and isopropanol.

7. The method according to claim 1, wherein the step of heating the dispersion is conducted at a temperature in a range of about 25° to about 105° C.

8. The method according to claim 1, wherein the neutralizing agent comprises at least one the group consisting of hydroxides of lithium, potassium and sodium.

9. The method according to claim 1, wherein the polyester is an etherified bisphenol A-containing polyester.

10. The method according to claim 1, wherein the first aqueous dispersion has a pH in a range of about 6 to about 8.

11. The aqueous dispersion provided according to the method of claim 1.

12. A toner resin composition, comprising
(a) the aqueous dispersion of claim 11; and
(b) a colorant.

13. The toner resin composition of claim 12, further comprising at least one of an inhibitor, a paraffin, a lubricant, and a shrink-reducing additive.

14. The toner resin of claim 12, further comprising a charge control agent.

15. The toner resin of claim 14, wherein the charge control agent is present in the composition at a concentration of about 1 to about 5 weight percent.
